(19) United States
(12) Patent Application Publication
(10) Pub. No.: US 2006/0097709 A1
(43) Pub. Date: May 11, 2006

(54) Linear voltage regulator

(75) Inventors: Yong-Zhao Huang, Shenzhen (CN); Yun Li, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/267,062

(22) Filed: Nov. 4, 2005

(30) Foreign Application Priority Data
Nov. 6, 2004 (CN) 200410052156.0

(51) Int. Cl. G05F 1/56

(52) U.S. Cl. 323/274

(57) ABSTRACT

A linear voltage regulator is provided for providing an output voltage to a load. In a preferred embodiment, the linear voltage regulator includes: a pass element for receiving an input voltage and providing an output voltage to a load, the pass element being adapted to be controlling by a controlling voltage; two resistors connected to each other in series for receiving the output voltage and providing a voltage reference; and a feedback circuit for receiving the voltage reference and providing the controlling voltage to the pass element. The linear voltage regulator is capable of providing a steady output voltage to the load, and a cost thereof being down at the same time.

### CROSS-REFERENCE TO RELATED APPLICATION

Relevant subject matter is disclosed in co-pending U.S. patent application Ser. No. ______ entitled “LINEAR VOLTAGE REGULATOR”, which is assigned to the same assignee with this application.

### BACKGROUND

1. Field of the Invention

The present invention relates to voltage regulators, and particularly to a linear voltage regulator for providing a regulated voltage to a load mounted on a motherboard.

2. General Background

Linear voltage regulators are widely used to supply power to electronic devices, such as to a load on a motherboard of a computer. Such linear voltage regulators are available in a wide variety of configurations for many different applications.

Referring to FIG. 9, a first typical linear voltage regulator includes a resistive voltage divider 1, a feedback circuit 2, and a regulating circuit 3. The resistive voltage divider 1 includes a resistor R1 and a resistor R2 connected to each other in series between a system voltage and a ground. A node between the resistor R1 and the resistor R2 provides a voltage reference Vref to the feedback circuit 2. The feedback circuit 2 includes an amplifier 22. The amplifier 22 has a non-inverting input terminal, an inverting input terminal, and an output terminal. The non-inverting input terminal is connected to the node of the resistive voltage divider 1 for receiving the voltage reference Vref. The inverting input terminal receives an output voltage Vout. The output terminal is connected to the regulating circuit 3 to provide a controlling voltage for controlling the regulating circuit 3. The regulating circuit 3 includes a metal-oxide-semiconductor field-effect transistor (MOSFET) Q1. The MOSFET Q1 includes a gate, a source, and a drain. The gate is connected to the output terminal of the amplifier 22 for receiving the controlling voltage. The drain is connected to a system voltage Vcc. The source is connected to a load for providing the output voltage Vout.

When the output voltage Vout suddenly increases, the controlling voltage decreases correspondingly. As a result, a voltage UGS (not shown in FIG. 10) between the gate and the source decreases. The decrease of the voltage UGS induces a reduction of a current through the MOSFET Q1. Therefore the output voltage Vout drops to a same level as before the sudden increase thereof. Contrarily, when the output voltage Vout suddenly decreases, the controlling voltage increases correspondingly. Then the voltage U_{GS} increases. The increase of the voltage U_{GS} induces an increasing of the current through the MOSFET Q1. Therefore the output voltage Vout climbs to a same level as before the sudden decrease thereof.

Referring to FIG. 10, a second typical linear voltage regulator includes a first transistor Q2, a second transistor Q3, and resistors R3 and R4. The resistors R3 and the resistor R4 are connected to each other in series between an output voltage Vout and a ground. A node between the resistors R3 and R4 provides a voltage reference Vref to the transistor Q2. The transistor Q2 as a feedback circuit feeds the output voltage Vout back to the transistor Q3. The transistor Q3 as a regulating circuit provides the output voltage Vout to a load.

However, a cost of the first typical linear voltage regulator is high because of employing the amplifier as the feedback circuit. The voltage reference Vref of the second typical linear voltage regulator is not steady because of employing the bipolar transistor as the feedback circuit.

What is needed, therefore, is a linear voltage regulator which is able to provide a steady current to a load and has a low cost.

### SUMMARY

A linear voltage regulator is provided for providing an output voltage to a load. In a preferred embodiment, the linear voltage regulator includes: a pass element for receiving an input voltage and providing an output voltage to a load, the pass element being adapted to be controlling by a controlling voltage; two resistors connected to each other in series for receiving the output voltage and providing a voltage reference; and a feedback circuit for receiving the voltage reference and providing the controlling voltage to the pass element. Since the feedback circuit employs a three-terminal adjustable shunt regulator, a cost of the linear voltage regulator is lower than that of the first typical linear voltage regulator. Because the three-terminal adjustable shunt regulator can provides a steadier voltage reference than a bipolar can, the embodiment of the invention can provides a steadier output voltage than the second typical linear voltage regulator illustrated in the background.

The linear voltage regulator is capable of providing a steady output voltage to the load, and a cost thereof being down at the same time.

Other advantages and novel features will become more apparent from the following detailed description of preferred embodiments when taken in conjunction with the accompanying drawings, in which:

### BRIEF DESCRIPTION OF THE DRAWINGS

FIG. 1 is a circuit diagram of a linear voltage regulator of a preferred embodiment of the present invention;

FIG. 2-6 are various embodiments of the pass element comprising two or three bipolar transistors;

FIG. 7-8 are various embodiments of the pass element comprising two MOSFETs;

FIG. 9 is a circuit diagram of a first typical linear voltage regulator; and

FIG. 10 is a circuit diagram of a second typical linear voltage regulator.

### DETAILED DESCRIPTION OF THE EMBODIMENTS

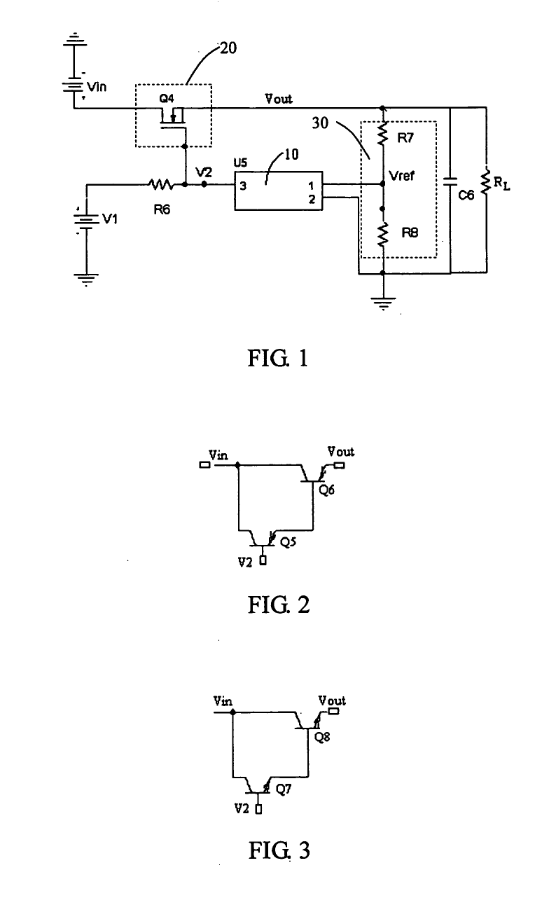

Referring to FIG. 1, in a preferred embodiment of the present invention, a linear voltage regulator includes a feedback circuit 10, a pass element 20, a resistive voltage divider 30. The feedback circuit 10 is a three-terminal adjustable shunt regulator in the embodiment. The feedback circuit 10 includes a first terminal 10-1 (shown as “1” in the circuit 10), a second terminal 10-2 (shown as “2” in the circuit 10), and a third terminal 10-3 (shown as “3” in the circuit 10). The first terminal 10-1 receives a voltage reference Vref. The second terminal 10-2 is grounded. The third terminal 10-3 provides a controlling voltage V2 to the pass element 20 for controlling the pass element 20, and is coupled to a system voltage V1 via a resistor R6. The pass element 20 is a metal-oxide-semiconductor field-effect transistor Q4 in the embodiment. The pass element 20 includes a gate as a controlling terminal, a drain as an input terminal, and a source as an output terminal. The gate is connected to the third terminal 10-3 for receiving the controlling voltage V2, and is coupled to the system voltage V1 via the resistor R6. The drain receives an input voltage Vin. The source provides an output voltage Vout to a load RL. The resistive voltage divider 30 includes a resistor R7 and a resistor R8 connected to each other in series between the output voltage and a ground. A node between the resistor R7 and the resistor R8 provides a voltage reference Vref to the first terminal 11 of the feedback circuit 10.

When the output voltage Vout suddenly increases, the voltage reference Vref increases correspondingly. Then the controlling voltage V2 decreases. A voltage Δ U_{GS} between the gate and the source decreases than before the sudden increase thereof. The decrease of the voltage Δ U_{GS} induces a decrease of the output voltage Vout. Therefore the output voltage Vout drops to a same level as before the sudden increase thereof.

Contrarily, when the output voltage Vout suddenly becomes lower, the voltage reference Vref becomes lower correspondingly. Then the controlling voltage V2 becomes higher. The voltage Δ U_{GS} becomes higher than before the sudden increase thereof. The increase of the voltage Δ U_{GS} induces an increase of the output voltage Vout. Therefore the output voltage Vout climbs to a same level as before the sudden increase thereof.

As shown in FIG. 2, the pass element 20 can include a PNP bipolar transistor Q5, and a PNP bipolar transistor Q6. An emitter of the PNP bipolar transistor Q5 is connected to a base of the PNP bipolar transistor Q6. Collectors of the PNP bipolar transistor Q5 and PNP bipolar transistor Q6 are connected to each other as the input terminal, and receive the input voltage Vin. A base of the PNP bipolar transistor Q5 as the controlling terminal receives the controlling voltage V2. An emitter of the PNP bipolar transistor Q6 as the output terminal provides the output voltage Vout.

As shown in FIG. 3, the pass element 20 can include an NPN bipolar transistor Q7, and an NPN bipolar transistor Q8. An emitter of the NPN bipolar transistor Q7 is connected to a base of the NPN bipolar transistor Q8. Collectors of the NPN bipolar transistor Q7 and NPN bipolar transistor Q8 are connected to each other as the input terminal, and receive the input voltage Vin. A base of the NPN bipolar transistor Q7 as the controlling terminal receives the controlling voltage V2. An emitter of the NPN bipolar transistor Q8 as the output terminal provides the output voltage Vout.

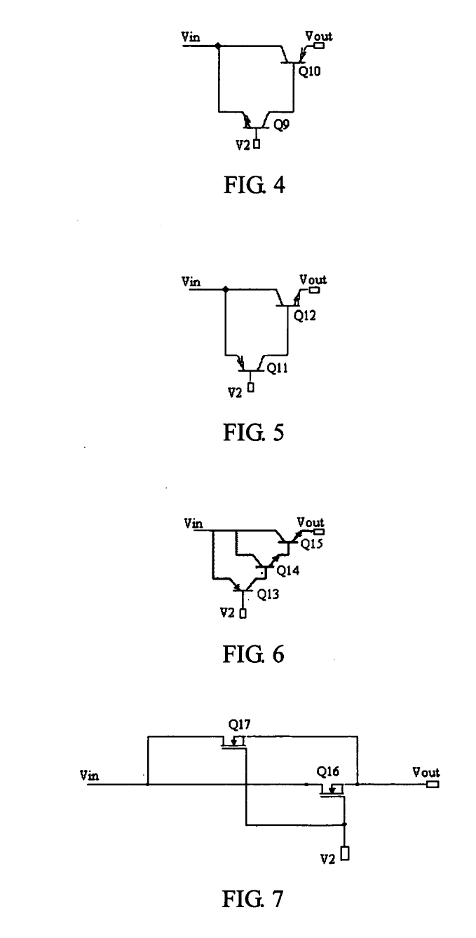

As shown in FIG. 4, the pass element 20 can include an NPN bipolar transistor Q9, and a PNP bipolar transistor Q10. A collector of the NPN bipolar transistor Q9 is connected to a base of the PNP bipolar transistor Q10. An emitter of the NPN bipolar transistor Q9 and a collector of the PNP bipolar transistor Q10 are connected to each other as the input terminal, and receive the input voltage Vin. A base of the NPN bipolar transistor Q9 as the controlling terminal receives the controlling voltage V2. An emitter of the PNP bipolar transistor Q10 as the output terminal provides the output voltage Vout.

As shown in FIG. 5, the pass element 20 can include a PNP bipolar transistor Q11, and an NPN bipolar transistor Q12. A collector of the PNP bipolar transistor Q11 is connected to a base of the NPN bipolar transistor Q12. An emitter of the PNP bipolar transistor QIl and a collector of the NPN bipolar transistor Q12 are connected to each other as the input terminal, and receive the input voltage Vin. A base of the PNP bipolar transistor Q11 as the controlling terminal receives the controlling voltage V2. An emitter of the NPN bipolar transistor Q12 as the output terminal provides the output voltage Vout.

As shown in FIG. 6, the pass element 20 can include a PNP bipolar transistor Q13, an NPN bipolar transistor Q14, and an NPN bipolar transistor Q15. A collector of the PNP bipolar transistor Q13 is connected to a base of the NPN bipolar transistor Q14. An emitter of the NPN bipolar transistor Q14 is connected to a base of the NPN bipolar transistor Q15. An emitter of the PNP bipolar transistor Q13, a collector of the NPN bipolar transistor Q14, and a collector of the NPN bipolar transistor Q15 are connected to each other as the input terminal, and receive the input voltage Vin. A base of the PNP bipolar transistor Q13 as the controlling terminal receives the controlling voltage V2. An emitter of the NPN bipolar transistor Q15 as the output terminal provides the output voltage Vout.

As shown in FIG. 7, the pass element 20 can include a N-channel MOSFET Q16, and a N-channel MOSFET Q17. Gates of the N-channel MOSFET Q16 and N-channel MOSFET Q17 are connected to each other as the controlling terminal, and receive the controlling voltage V2. Drains of the N-channel MOSFET Q16 and N-channel MOSFET Q17 are connected to each other as the input terminal, and receive the input voltage Vin. Sources of the N-channel MOSFET Q16 and N-channel MOSFET Q17 are connected to each other as the output terminal, and provide the output voltage Vout.

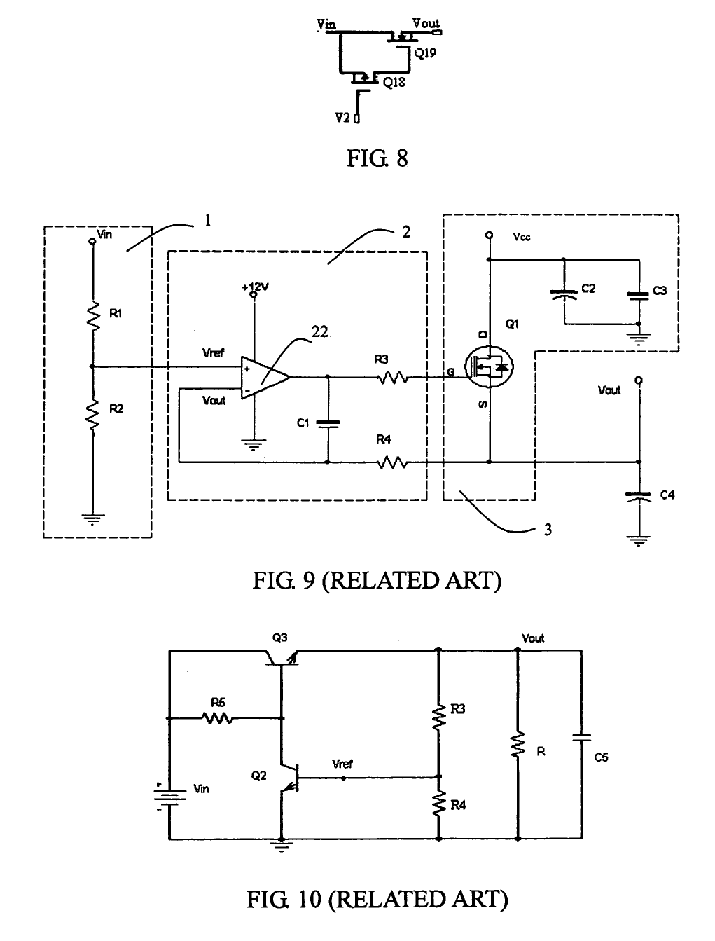

As shown in FIG. 8, the pass element 20 can include a P-channel MOSFET Q18, and an N-channel MOSFET Q19. A drain of the P-channel MOSFET Q18 is connected to a gate of the N-channel MOSFET. A gate of the P-channel MOSFET Q18 as the controlling terminal receives the controlling voltage V2. A source of the P-channel MOSFET Q18 and a drain of the N-channel MOSFET Q19 are connected to each other as the input terminal, and receive the input voltage Vin. A source of the N-channel MOSFET Q19 as the output terminal provides the output voltage Vout.

In the illustrated embodiments, because that the feedback circuit 10 employs the three-terminal adjustable shunt regulator, a cost is lower than that of the first typical linear voltage regulator illustrated in the background. At the same time, because the three-terminal adjustable shunt regulator can provide a steadier voltage reference than a bipolar can, the embodiments of the invention can provide a steadier output voltage than the second typical linear voltage regulator illustrated in the background.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A linear voltage regulator comprising:
a pass element receiving an input voltage and providing an output voltage to a load, the pass element controlled by a controlling voltage;
two resistors connected to each other in series for receiving the output voltage and providing a voltage reference; and
a feedback circuit receiving the voltage reference and providing the controlling voltage to the pass element.

2. The linear voltage regulator as claimed in claim 1, wherein the pass element includes a controlling terminal connected to the feedback circuit for receiving the controlling voltage and a system voltage, an input terminal for receiving the input voltage, and an output terminal for providing the output voltage.

3. The linear voltage regulator as claimed in claim 2, wherein the pass element comprises two bipolar transistors connected to each other.

4. The linear voltage regulator as claimed in claim 2, wherein the pass element comprises two MOSFET (metal-oxide-semiconductor field-effect transistor) connected to each other.

5. The linear voltage regulator as claimed in claim 1, wherein the feedback circuit includes a three-terminal adjustable shunt regulator, the three-terminal adjustable shunt regulator includes a first terminal for receiving the voltage reference, a second terminal grounded, and a third terminal connected to the pass element for proving the controlling voltage, and the third terminal connected to a system voltage.

6. The linear voltage regulator as claimed in claim 5, wherein a node between the two resistors is connected to the first terminal for providing the voltage reference.

7. A linear voltage regulator comprising:
a pass element including a controlling terminal, an input terminal and an output terminal, the controlling terminal receiving a controlling voltage, the input terminal receiving an input voltage, the output terminal providing an output voltage;
a resistive voltage divider for receiving the output voltage and providing the voltage reference; and
a three-terminal adjustable shunt regulator including a first terminal for receiving the voltage reference, an second terminal being grounded, and a third terminal connected to the controlling terminal of the pass element for providing the controlling voltage.

8. The linear voltage regulator as claimed in claim 7, wherein the resistive voltage divider includes two resistors, the resistors are connected to each other in series between the output terminal and a ground, and a node between the resistors connected to the first terminal provides the voltage reference.

9. The linear voltage regulator as claimed in claim 7, wherein the pass element comprises two bipolar transistors, the two bipolar transistors are connected to each other.

10. The linear voltage regulator as claimed in claim 7, wherein the pass element comprises two MOSFETs (metal-oxide-semiconductor field-effect transistors), the two MOSFETs are connected to each other.

11. The linear voltage regulator as claimed in claim 7, wherein the controlling terminal and the third terminal are coupled to a system voltage via a current limiting resistor.

12. A voltage regulator comprising:
a power source providing an input voltage;
a pass element electrically connecting with said power source for accepting said input voltage and generating an output voltage for use outside said voltage regulator; and
a feedback circuit electrically connecting with said pass element so as to accept a part of said output voltage as one of inputs thereof and incorporate with a system voltage to generate a controlling voltage back to said pass element based on said accepted part of said output voltage, and said controlling voltage back to said pass element capable of controlling a working status of said pass element.

13. The voltage regulator as claimed in claim 12, wherein said feedback circuit comprises a three-terminal adjustable shunt regulator.

14. The voltage regulator as claimed in claim 12, wherein said pass element comprises a selective circuit of a metal-oxide-semiconductor field-effect transistor (MOSFET), two PNP bipolar transistors, two NPN bipolar transistors, an NPN bipolar transistor and a PNP bipolar transistor, a PNP bipolar transistor and an NPN bipolar transistor, a PNP bipolar transistor and two NPN bipolar transistors, two parallel-connected N-channel MOSFETs, and a P-channel MOSFET and an N-channel MOSFET.

15. The voltage regulator as claimed in claim 12, wherein a resistive voltage divider is electrically connected between said feedback circuit and said pass element so as to accept said output voltage of said pass element and provide said part of said output voltage to said feedback circuit.
